(19) United States
(12) Patent Application Publication
(10) Pub. No.: US 2006/0093345 A1
(43) Pub. Date: May 4, 2006

(54) Positioning structure of emergency power supply for use in a camera device

(76) Inventor: Michael Shih Fong Jan, Rowland Heights, CA (US)

Correspondence Address: BRUCE H. TROXELL, SUITE 1404, 5205 LEESBURG PIKE, FALLS CHURCH, VA, 22041, US

(21) Appl. No.: 10/978,453

(22) Filed: Nov. 2, 2004

(51) Int. Cl. G03B 7/26

(52) U.S. Cl. 396/278

(57) ABSTRACT

The present invention discloses a positioning structure of emergency power supply for use in a camera device, which can be rapidly connected and positioned to a camera device, so that the camera device can use the functions provided by the emergency power supply. The positioning structure includes: a main body, which is configured with a connection terminal for electrical connection with the charging socket configured on the camera device to provide the power supply required in the operation of the camera device; a positioning structure, which can be connected and positioned to the main body, and the positioning structure is configured with a first positioning device to be connected and positioned to the positioning hole disposed at the bottom of the camera device, and further configuring a screw hole on the positioning structure or at the bottom of the main body with the same size as the positioning hole at the bottom of the camera device. With the above-mentioned structural design, the present invention can use the design of the positioning structure for rapid connection and positioning of the main body of the emergency power supply with the camera device for the convenience of the user.

### FIELD OF THE INVENTION

The present invention relates to a positioning structure of emergency power supply for use in a camera device, and particularly to a positioning structure of emergency power supply for use in a camera device, which uses the positioning hole at the bottom of the camera device to rapidly connect and position the main body of the emergency power supply with the camera device.

### BACKGROUND OF THE INVENTION

Along with technological advancement, many innovative technologies have been applied to products used in daily lives to bring convenience to people. In the case of still camera and video camera, they have been the best recording tools in life or travel. With the progress of technology, camera has been advanced from the conventional negative exposure to digital camera that can generate digital data file and perform data editing, storage and transmission with the use of computer. Nowadays, digital camera offers high pixels (resolution), and is miniaturized for easy carrying. Video camera is also advanced from the conventional analog to digital video camera that can generate digital image data, and similarly perform data editing, storage and transmission with the use of computer, which brings significantly more convenience than the conventional camera or video camera.

However, no matter whether it is conventional still camera, video camera, or the most popular digital camera or digital video camera, almost all users encounter the same kind of problem in actual use, that is, insufficient power. For operational convenience, digital cameras or digital video cameras nowadays come with a 2˜4 inches liquid crystal display (LCD). Although it is convenient for viewing, the LCD consumes considerable power. Furthermore, manufacturers routinely use the rechargeable Li-battery with special specification to reduce the volume of the camera for easy carrying. The Li-battery can provide more power capacity than conventional battery. Although manufactures all attach a charger to their camera, it still cannot satisfy the user's needs in most occasions. For example, when the user is going out on a trip and likes to capture and record a whole day schedule, the batteries he or she brings along will not be adequate. In other occasions, users would find out that they forgot to bring their camera battery charger after they have boarded a flight or reached their destination. Because the battery voltage or connector used by the camera devices from different manufactures all have special specifications, it is very difficult to buy those items abroad. Because trips are unrepeatable, the absence of a battery or battery charger sometimes leads to much regret.

Therefore, if users have an emergency power supply or charging device using standard dry battery and having a connector that can be mounted on the charging socket configured on the camera, it would allow them to easily find sufficient batteries as substitute power supply. The emergency power supply carries certain weight and must be connected to the charging socket of the camera device. But like-kind products currently on the market do not provide any connection or positioning structure to the camera device. That means the user must hold the camera and the emergency power supply at the same time to shoot, which is inconvenient and might cause either or both devices on hand to drop. As a result, either the camera is damaged, or the connection portion between the emergency power supply and the camera device is damaged due to the exertion of external force, causing a lot of inconvenience and headache for the user.

In order to address the drawbacks of the conventional emergency power supply not being able to be connected and positioned on the camera device, the inventor employed many years of experiences in the manufacturing of related products, and underwent continuous research, experiment and testing to produce an improved structure according to the present invention.

### SUMMARY OF THE INVENTION

The main object of the present invention is to provide a positioning structure of emergency power supply for use in camera device, which can be rapidly connected and positioned on a camera device, so that the camera device can use the functions provided by the emergency power supply for operation. The positioning structure comprises: a main body, which is configured with a connection terminal for electrical connection with the charging socket configured on the camera device to provide the power supply required in the operation of the camera device; a positioning structure, which can be connected and positioned on the main body, and the positioning structure is configured with a first positioning device to be connected and positioned to the positioning hole disposed at the bottom of the camera device. With the above-mentioned structural design, the emergency power supply can rapidly mount on the camera device to make it convenient for the user in actual operation.

Another object of the present invention is to provide a positioning structure of emergency power supply for use in a camera device, wherein a screw hole is further configured at the positioning structure or at the bottom of the main body having the same size as the positioning hole at the bottom of the camera device. The camera device after mounting with the present invention can still have other accessories (such as the tripod) connected without having other existing functions affected.

### BRIEF DESCRIPTIONS OF THE FIGURES

FIG. 1 is a three-dimensional exploded diagram of the present invention.

FIG. 2 is a three-dimensional sectional diagram of the present invention.

FIG. 3 is a first embodiment for the connection of the positioning structure and the main body according to the present invention.

FIG. 4 is a second embodiment for the connection of the positioning structure and the main body according to the present invention.

FIG. 5 is a third embodiment for the connection of the positioning structure and the main body according to the present invention.

FIG. 6A is a three-dimensional appearance diagram of the first embodiment for the first positioning device according to the present invention.

FIG. 6B is a cross-sectional diagram for the connection of the first embodiment for the first positioning device and the positioning hole according to the present invention.

FIG. 7A is a three-dimensional appearance diagram of the first embodiment for the first positioning device according to the present invention.

FIG. 7B is a cross-sectional diagram for the connection of the first embodiment for the first positioning device and the positioning hole according to the present invention.

FIG. 8A is a three-dimensional appearance diagram of the first embodiment for the first positioning device according to the present invention.

FIG. 8B is a cross-sectional diagram for the connection of the first embodiment for the first positioning device and the positioning hole according to the present invention.

FIG. 9 is an appearance diagram for the main body with screw hole configured at the bottom according to the present invention.

### DETAILED DESCRIPTION OF THE INVENTION

The effect and features of present invention are further depicted along with the attached drawings below.

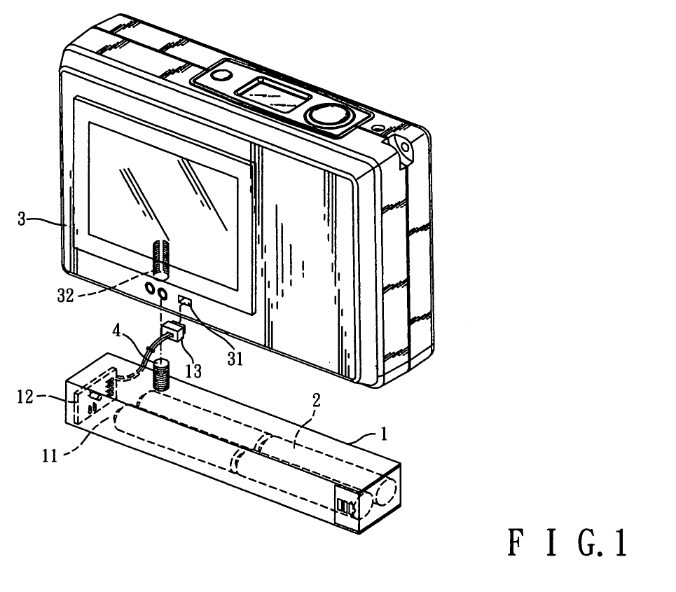

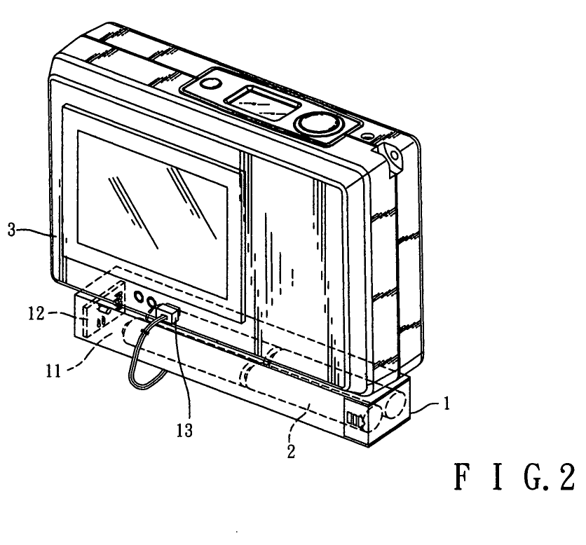

First, referring to FIG. 1 and FIG. 2 which are the three-dimensional exploded diagram and the three-dimensional sectional diagram of the positioning structure of the emergency power supply for the camera device. The positioning structure of emergency power supply for use in a camera device according to the present invention mainly comprises: a main body 1, which is configured with an accommodation space 11 and a control circuit 12 for accommodating the battery 2 of standard specification and adjusting the output voltage, and the main body 1 is configured with a terminal 13 for electrical connection with the charging socket 31 configured on the camera device 3 to provide the power required in the operation of the camera device 3; a positioning structure 4, which is connected and positioned on the main body 1, and configured with a first positioning device 41 to be connected and positioned to the positioning hole 32 disposed at the bottom of the camera device 3. With the above-mentioned structural design, the present invention uses positioning structure 4 to rapidly connect and position on the main body 1 of the emergency power supply for camera device 3. Such design is convenient for the camera user and provides practical effect.

The key feature of the present invention is the use of the first positioning device 41 on the positioning structure 4 for fast connection and positioning to the positioning hole 32 disposed at the bottom of the camera device 3. Camera devices of all brands and types will come with the same size of positioning hole 32 at their bottom. Hence the above-mentioned structural design will be suitable for various brands and types of camera device, which greatly enhances its scope of application and versatility and achieves practical effect.

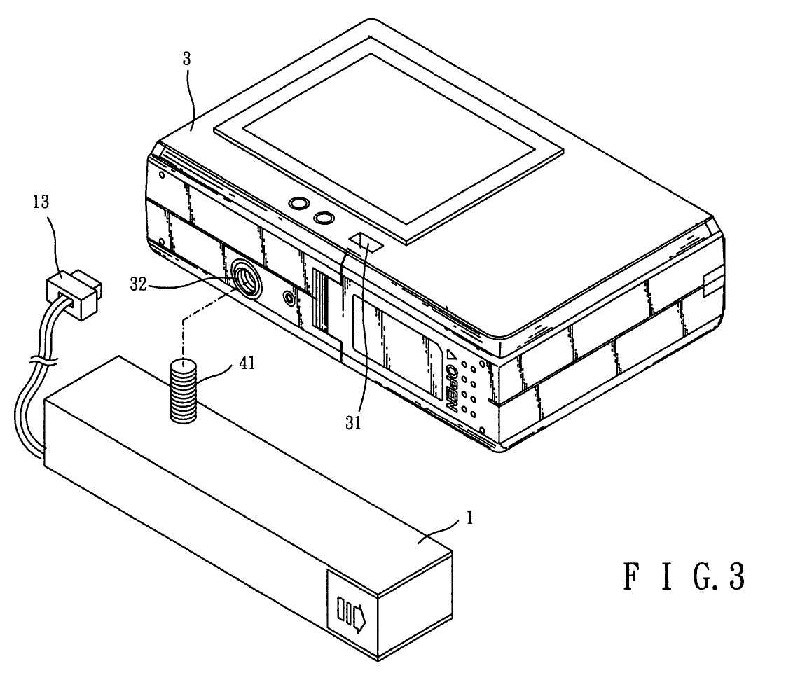

In the above-mentioned structure, the connection manner between the positioning structure 4 and the main body 1 and the form of the positioning structure 4 itself has many variations which cannot be all elaborated here. Below are a few embodiments of the present invention. First, referring to FIG. 3 which is the first embodiment of the connection method for the positioning structure and the main body according to the present invention, wherein the positioning structure 4 is integrated with the main body 1, that is, the first positioning device 41 for the connection and positioning to the positioning hole 32 configured at the bottom of the camera device 3 is directly arranged on the main body 1 of the present invention, and the main body 1 of the present invention can use the first positioning device 41 for mounting on the positioning hole 32 at the bottom of the camera device to achieve the positioning effect.

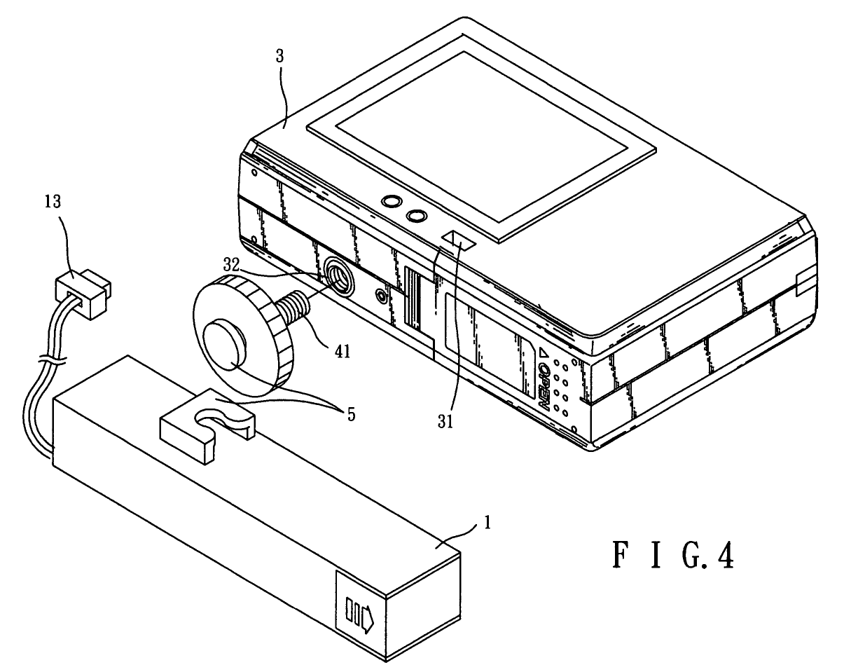

Next, referring to FIG. 4 which is the second embodiment of the connection method for the positioning structure and the main body according to the present invention; wherein, the positioning structure 4 and the main body 1 are flexibly locked by the arrangement of a locking structure 5. During use, it first positions or dismantles the connection assembly of the first positioning device 41 configured on the positioning device 4 to or from the positioning hole 32 at the bottom of the camera device 3, and then locks and positions the main body 1 with the positioning structure 4.

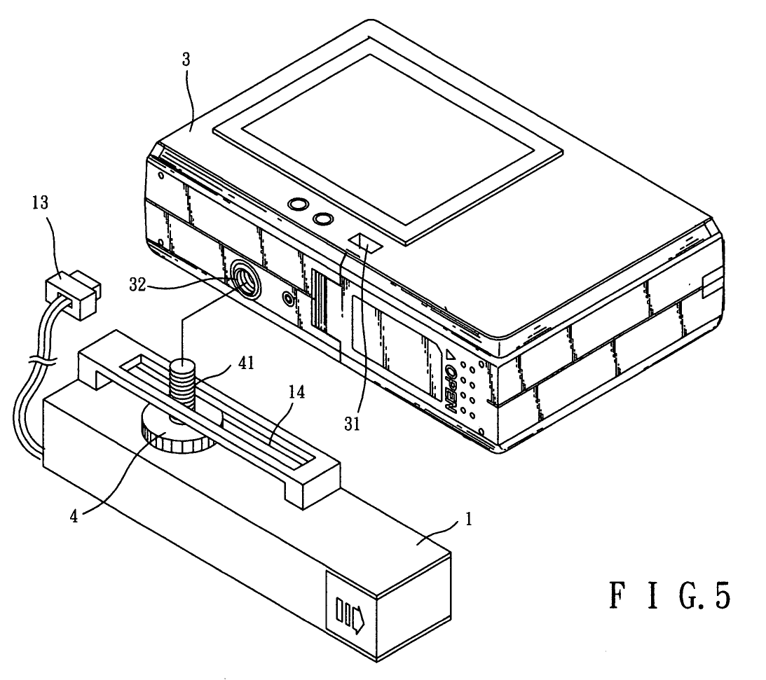

Referring to FIG. 5 which is the third embodiment of the connection method for the positioning structure and the main body according to the present invention; wherein, the main body 1 is configured with at least a long notch 14 for the penetration of the first positioning device 41 of the positioning structure 4, so that the positioning structure 4 and the first positioning device 41 thereon can freely move along the long notch 14. When the user has adjusted the angle and position, he only needs to connect and position the first positioning device 41 to the positioning hole 32 disposed at the bottom of the camera device 3, which not only achieves the purpose of connection and positioning the main body 1 on the camera device 3, the relative position and angle of the main body 1 to the camera device 3 can also be adjusted freely. Thus, the present invention can provide better engagement in certain camera devices with specialized specification.

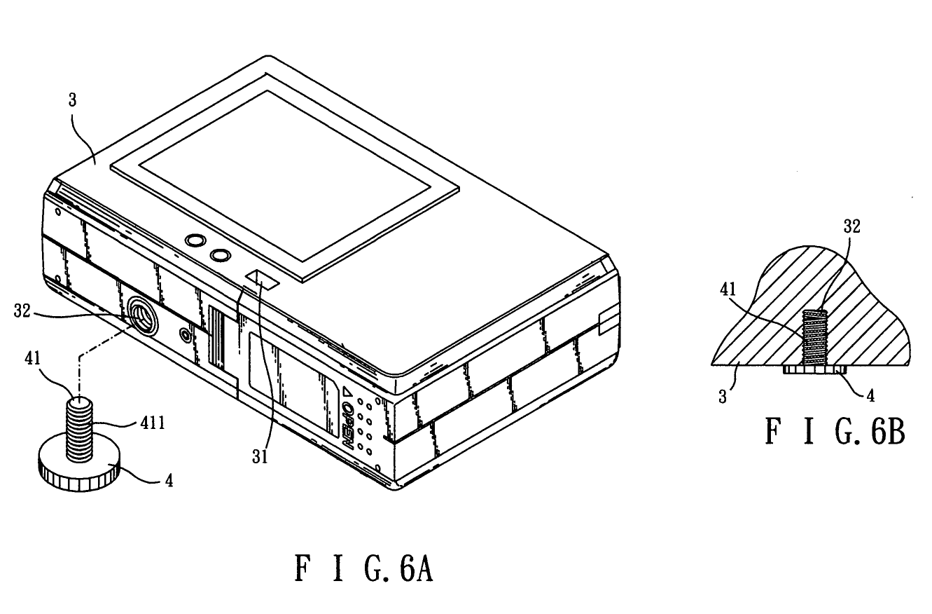

In addition to having many variations in the connection methods between the positioning structure and the main body, the aforementioned structure can also have many structural variations for the first positioning device 41 configured on the positioning structure 4 for the connection and positioning to the positioning hole 32 at the bottom of the camera device 3 which is typically a screw hole. Below are a few examples: referring to FIG. 6A and FIG. 6B which are the three-dimensional appearance diagram and the cross-sectional diagram for the connection with the positioning hole; wherein, the outer rim of the first positioning device 41 is disposed with external threads 411 for the screw-positioning with the positioning hole 32 configured at the bottom of the camera device 3 so that the two can be secured together in a screw-locking manner.

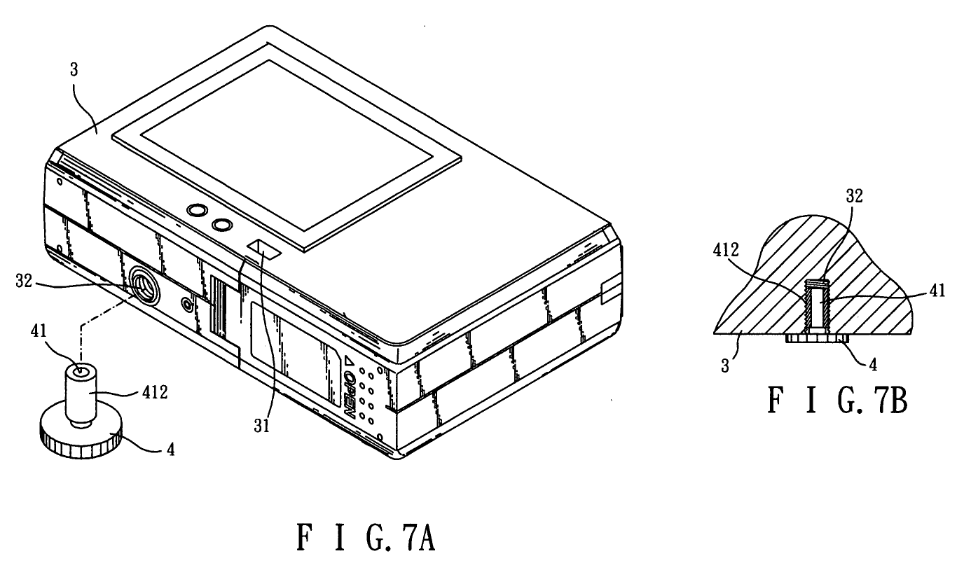

Referring to FIG. 7A and FIG. 7B which are the three-dimensional appearance diagram of the second embodiment for the first positioning device and the cross-sectional diagram for the connection with the positioning hole; wherein, the periphery of the first positioning device 41 opposite to the positioning hole 32 is configured with a rubber layer or an elastomer 412 made of similar material. The diameter of the elastomer 412 is slightly larger than the positioning hole 32 configured at the bottom of the camera device 3, so that the first positioning device 41 can directly insert one end of the elastomer 412 into the positioning hole 32 configured at the bottom of the camera device 3 to achieve snug positioning effect.

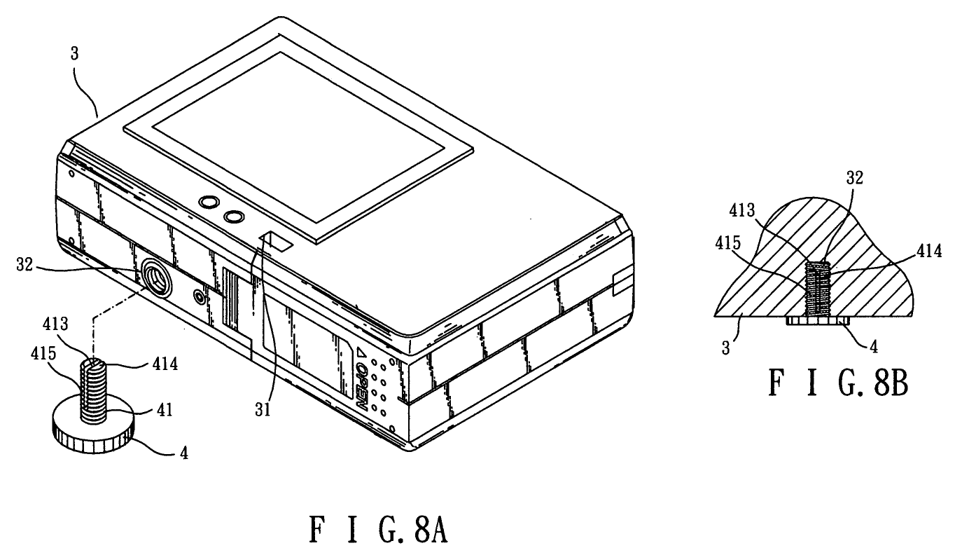

Referring to FIG. 8A and FIG. 8B which are the three-dimensional appearance diagram of the third embodiment for the first positioning device and the cross-sectional diagram for the connection with the positioning hoe; wherein, the top of the first positioning device 41 is configured with at least an opening notch 413 so as to form an elastic locking portion 414 at the front end of the first positioning device 41, and the locking portion 414 is configured with several flanges 415 associated with the positioning hole 32 at the outer rim opposite to the positioning hole 32, so that the first positioning device 41 can directly insert the locking portion 414 into the positioning hole 32 configured at the bottom of the camera device 3 to achieve fast locking and positioning effect.

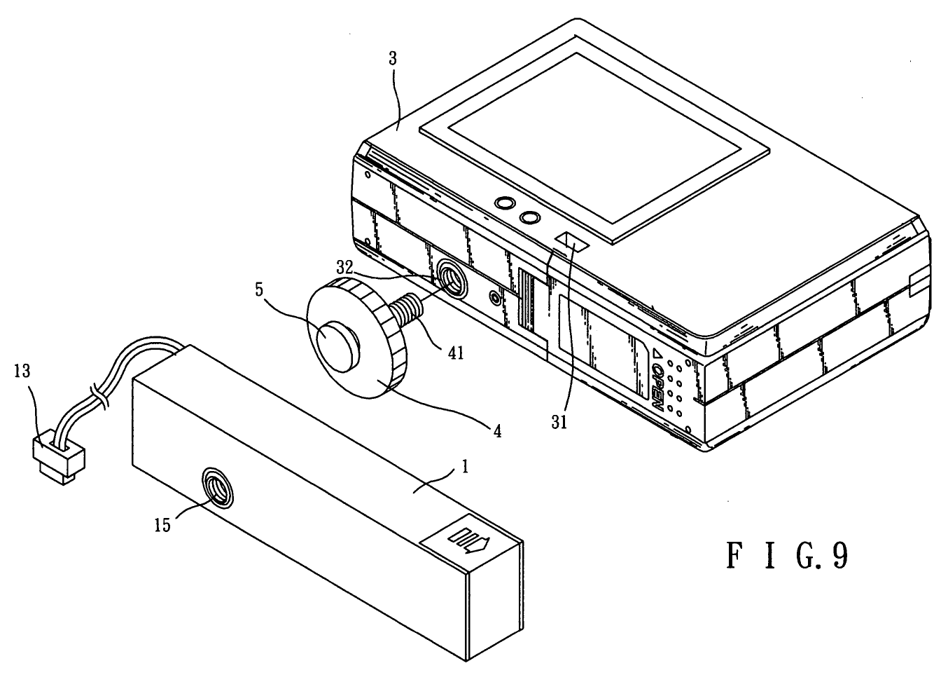

The present invention targets the positioning hole 32 configured at the bottom of the camera device 3 for positioning the main body 1 in the present invention. Thus the present invention can choose to configure a screw hole 15 having the same size as the positioning hole at the bottom of the camera device on the main body 1 or the positioning structure 4 in the present invention (as shown in FIG. 9) that allows the mounting of other accessories (such as tripod) on camera device 3 after installing the present invention.

Preferred embodiments of the present invention have been disclosed. All modifications and alterations without departing from the spirits of the invention, such as the changes to the relationship between the positioning structure and the main body or the shape of the locking structure or the method of locking, shall remain within the protected scope and claims of the invention.

In summary, the positioning structure for emergency power supply for use in a camera device according to the present invention is characterized in having an easy structure and easy for fabrication. With the design using the positioning hole configured at the bottom of each type of camera device as the connection and positioning target for the connection with the main body of the present invention, the present invention not only provides convenience for users in operation by integrating the emergency power supply with the camera device and the better safety for the camera device to prevent it from falling, the positioning structure designed in the present invention can also be applied in different brands or models to allow extensive application.

What is claimed is:

1. A positioning structure of emergency power supply for use in a camera device, which can rapidly connect and position a main body of an emergency power supply with a camera device, so that the camera device can be operated using the power supplied by the emergency power supply, comprising:
a main body configured with an accommodation space and a control circuit for accommodating a battery of standard specification and adjusting an output voltage, and a terminal for electrical connection with a charging socket configured on the camera device to provide the power required in the operation of the camera device; and
a positioning structure connected and positioned on the main body, and configured with a first positioning device to be connected and positioned to a positioning hole disposed at a bottom of the camera device.

2. The positioning structure of emergency power supply for use in a camera device of claim 1, wherein the positioning structure is integrated with the main body as a whole.

3. The positioning structure of emergency power supply for use in a camera device of claim 1, wherein the positioning structure and the main body uses the configuration of a locking structure for flexible locking assembly or dismantling.

4. The positioning structure of emergency power supply for use in a camera device of claim 1, wherein the main body is configured with at least a long notch for the penetration of the first positioning device of the positioning structure, so that the positioning structure and the first positioning device thereon can freely move along the long notch.

5. The positioning structure of emergency power supply for use in a camera device of claim 1, wherein the outer rim of the first positioning device is configured with an external thread for the screw-positioning with the positioning hole disposed at the bottom of the camera device.

6. The positioning structure of emergency power supply for use in a camera device of claim 1, wherein the outer rim of the first positioning device opposite to the positioning hole is configured with an elastomer, and a diameter of the elastomer is slightly larger than the positioning hole disposed at the bottom of the camera device.

7. The positioning structure of emergency power supply for use in a camera device of claim 1, wherein a top of the first positioning device is configured with at least an opening notch so as to form an elastic locking portion at a front end of the first positioning device, and the locking portion is configured with several flanges associated with the positioning hole at an outer rim opposite to the positioning hole.

8. The positioning structure of emergency power supply for use in a camera device of claim 1, wherein the positioning structure is configured with a screw hole having the same size as the positioning hole disposed at the bottom of the camera device.

9. The positioning structure of emergency power supply for use in a camera device of claim 1, wherein the main body of the present invention is configured with a screw hole having the same size as the positioning hole disposed at the bottom of the camera device.
